(19) United States
(12) Patent Application Publication
(10) Pub. No.: US 2006/0232738 A1
(43) Pub. Date: Oct. 19, 2006

(54) Active-matrix display panel

(76) Inventors: Tung-Liang Lin, Hsinchu (TW); Yu-Chen Hsu, Hsinchu (TW); Chuan-Feng Liu, Hsinchu (TW); Chia-Hao Kuo, Hsinchu (TW); Yu-Chun Teng, Hsinchu (TW)

Correspondence Address: Daniel R. McClure;THOMAS, KAYDEN, HORSTEMEYER & RISLEY, L.L.P., 100 Galleria Parkway, Suite 1750, Atlanta, GA, 30339, US

(21) Appl. No.: 11/285,956

(22) Filed: Nov. 23, 2005

(30) Foreign Application Priority Data
Apr. 19, 2005 (TW) 94112346

(51) Int. Cl. G02F 1/1345

(52) U.S. Cl. 349/149

(57) ABSTRACT

An active-matrix display panel including a display area, a peripheral region and a fanout circuitry is provided. The peripheral region is connected with at least one side of the display area. The fanout circuitry is arranged on the peripheral region and is a multi-layered routing structure. By using the multi-layered routing structure aforementioned, the layout flexibility is improved significantly.

### CROSS-REFERENCE TO RELATED APPLICATION

This application claims the priority benefit of Taiwan application serial no. 94112346, filed on Apr. 19, 2005. All disclosure of the Taiwan application is incorporated herein by reference.

### BACKGROUND OF THE INVENTION

1. Field of Invention

The present invention relates to an active-matrix display panel, more particularly, to an active-matrix display panel having a multi-layered fanout circuitry.

2. Description of Related Art

Following the rapid developments of the display industry, the flat-panel display is required to provide higher quality. As the image resolution of the display is constantly improving, the module size of the product becomes smaller and the weight of the product becomes lighter. The corresponding packaging technology was evolved from the Chip On Board (COB) technology to the Tape Automated Bonding (TAB) technology, and is further evolved to the present fine pitch Chip On Glass (COG) technology.

In commonly used COG technology, a display panel is provided with a display area and a peripheral region. The display area is the main part where image is displayed, and in the periphery region, the external circuitry, including the so-called “fanout” circuit, is located. In addition, a driver-bonding area is located in the peripheral region for connecting driver integrated circuit (IC) through bumps on the driver.

The fanout circuitry mentioned above is to make connections from the display area to the driver bonding area, and thus to the driver IC. In general, the bump pitch of the driver integrated circuit is smaller than the pixel pitch of the display area. A fan-shaped connection circuit is thus formed.

For the portable applications, the size of the entire display module, especially the peripheral area, tends to become smaller and smaller for easy carry. The fanout circuitry is crowded in such a small region that the fanout pitches, as well as the spacing between traces and the line width of the trace are all restricted, and the flexibility of wiring is accordingly decreased. The layout arrangement of the fanout circuitry will become more and more difficult when the number of fanout traces is increased due to the user-side request of higher display resolution. Therefore, how to effectively utilize the limited peripheral region with the variation of the structure to increase the layout flexibility of the fanout circuitry is an issue to be solved urgently.

### SUMMARY OF THE INVENTION

The present invention is directed to provide an active-matrix display panel which uses a multi-layered routing structure to increase the layout flexibility of the fanout circuitry on the peripheral region.

The present invention provides an active-matrix display panel including a display area, a peripheral region and a first fanout circuitry. The peripheral region is connected to at least one side of the display area, and the first fanout circuitry is a multi-layered structure and disposed on the peripheral region.

In an embodiment of the present invention, the active-matrix display panel further includes a driving circuit located on the peripheral region and electrically connected to the first fanout circuitry. The driving circuit can be a driver integrated circuit (driver IC). The driver IC is bonded on the peripheral region through appropriate bonding processes.

In an embodiment of the present invention, the active-matrix display panel further includes an external circuitry which is electrically connected with the driving circuit.

In an embodiment of the present invention, the active-matrix display panel further includes a control circuit interface. Specifically, the control circuit interface is electrically connected with the first fanout circuitry through an external circuitry and a driver IC.

In an embodiment of the present invention, the first fanout circuitry includes a plurality of conductive circuit layers and a plurality of dielectric layers. The above conductive circuit layers and the dielectric layers are alternately stacked on the peripheral region. In addition, each of the conductive circuit layers includes a plurality of traces, while two adjacent traces are located on different conductive circuit layers respectively.

In an embodiment of the present invention, the active-matrix display panel can further include a second fanout circuitry disposed on the peripheral region. The first fanout circuitry may be a fanout circuitry for source drivers (or a fanout circuitry for gate drivers) while the second fanout circuitry may be a fanout circuitry for gate drivers (or a fanout circuitry for source drivers). Further, the second fanout circuitry can be a single-layered routing structure or a multi-layered routing structure.

Since the first fanout circuitry of the present invention is a multi-layered routing structure, the number of traces of the layout required in each conductive circuit layer can be significantly reduced. As a result, the problem of crowded traces can be effectively avoided. Moreover, the line width of the traces and the spacing between the traces are also considered. Accordingly, the production yield of the display panel can be increased. In addition, since the first fanout circuitry is a multi-layered routing structure, the layout flexibility can be improved.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

FIG. 1 is a top view of the active-matrix display panel of the present invention.

FIG. 2A is a cross-sectional view of an implementation of the first fanout circuitry, which is taken along the line A-A′ in FIG. 1.

FIG. 2B is a cross-sectional view of another implementation of the first fanout circuitry, which is taken along the line A-A′ in FIG. 1.

FIG. 3 is a detailed view of the Thin Film Transistor (TFT) array substrate of area A in FIG. 1.

FIGS. 4A and 4B respectively are a detailed view of a pixel region and a cross-sectional view of the Thin Film Transistor of a pixel region in FIG. 3.

FIGS. 4C and 4D respectively are the cross-sectional views of the adjacent first trace and second trace in the first fanout circuitry in FIG. 1 along the lines II-II′ and III-III′.

FIG. 5 is a cross-sectional view of the structure of the second trace formed on the substrate in another embodiment of the present invention.

### DESCRIPTION OF THE PREFERRED EMBODIMENTS

Typically, active-matrix display driving method can be applied to various display technologies, such as Liquid Crystal Display (LCD), Organic Electro-Luminescence Display (OEL), Plasma Display Panel (PDP), Field Emission Display (FED), carbon nanotubes (CNT) and E-ink display, etc. The structure of each kind of display panel includes a display area where the image is displayed, and a peripheral region where driving circuits and other related circuitry are disposed to drive the components within the display area.

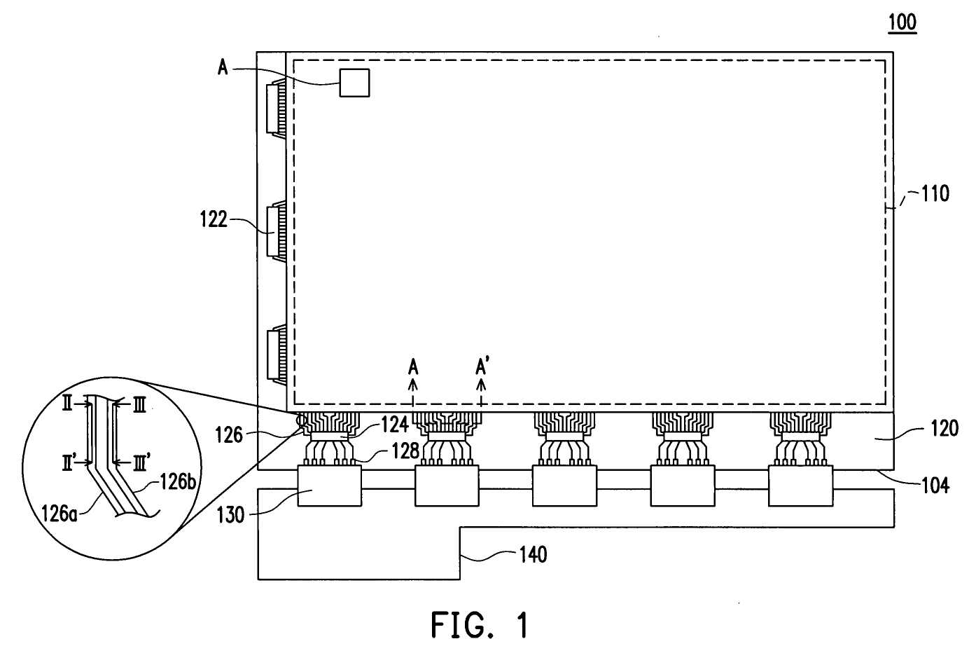

FIG. 1 is a top view of the active-matrix display panel in an embodiment of the present invention, in which an active-matrix LCD panel is illustrated as an example. However, the present invention can also be applied to other types of active-matrix display panels without being limited to the application to LCDs.

With reference to FIG. 1, the active-matrix display panel 100 of the present invention includes a display area 110, a peripheral region 120 and a first fanout circuitry 126. The peripheral region 120, as an external electrical connection interface, is connected to at least one side of the display area 110. And related circuits, including driving circuits and connection circuits of driving circuits are arranged on the peripheral region 120. In the present embodiment, the peripheral region 120 is connected to two adjacent sides of the display area 110. The first fanout circuitry 126 is arranged in the peripheral region 120.

Still with reference to FIG. 1, in the active-matrix display panel 100 of the present invention, the gate driving circuit (gate driver) 122, the data driving circuit (source driver) 124, the first fanout circuitry 126 and the external circuitry 128 are arranged on the peripheral region 120. It can be seen from FIG. 1 that the data driving circuit (source driver) 124 is connected respectively to the first fanout circuitry 126 and the external circuitry 128. In a preferred embodiment, the gate driving circuit (gate driver) 122 can be a gate driver IC, and the data driving circuit (source driver) 124 can be a data driver IC.

The active-matrix display panel 100 further includes a flexible printed circuitry 130 and a control circuit interface 140. The control circuit interface 140 is electrically connected to the external circuitry 128 via the flexible printed circuitry 130. In a preferred embodiment of the present invention, the control circuit interface 140 may be a control circuit board.

According to above description, the image data output from user end (e.g. personal computers, electronic products, etc.) is transmitted to the display area 110 through the control circuit interface 140, the flexible printed circuitry 130, the external circuitry 128, the data driving circuit (source driver) 124 and the first fanout circuitry 126, so that the active-matrix display panel 100 generates the desired image. Alternatively, the control circuit interface 140 and the external circuitry 128 in the peripheral region 120 can also be electrically connected by other methods. The connection method between the control circuit interface 140 and the external circuitry 128 described above is only a illustration rather than a limitation.

The first fanout circuitry 126 is extended from the data lines in the display area 110. The first fanout circuitry 126 of the present invention is a multi-layered structure, which includes a plurality of conductive layers and a plurality of dielectric layers stacked alternately on the peripheral region 120. With such a multi-layered structure, the number of fanout traces required in one conductive layer can be significantly reduced. The pitch between traces in the same layer will therefore be increased and a larger line width and sufficient line spacing can be achieved without increasing the fanout area. Moreover, since the first fanout circuitry 126 is a multi-layered structure, the flexibility of the circuit layout is significantly improved.

Two types of structure of the first fanout circuitry 126 will be described below in conjunction with the drawings. However, there could be various arrangements for multi-layered routing structure, the following embodiment is an illustration rather than a limitation to the present invention.

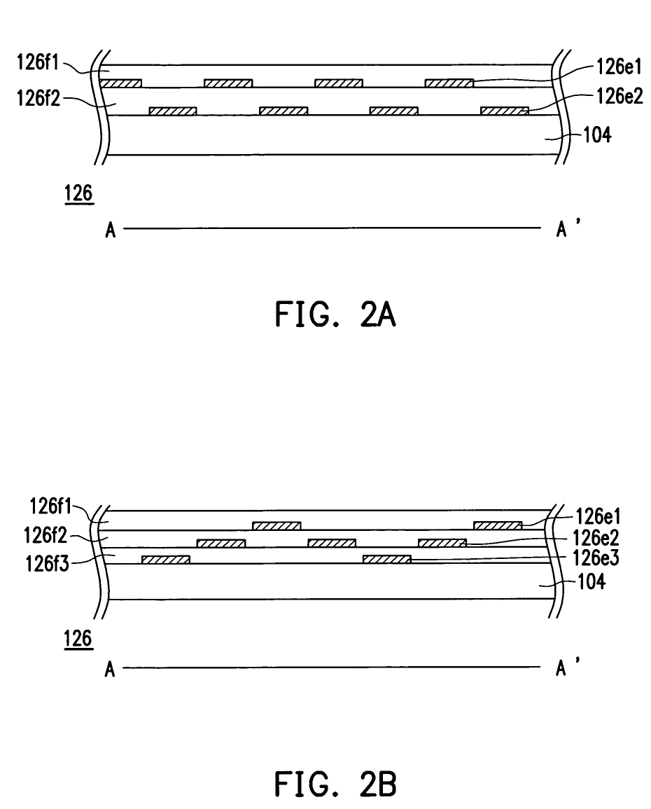

FIG. 2A is a cross-sectional view of an implementation of the first fanout circuitry 126, which is taken along the line A-A′ in FIG. 1. With reference to FIG. 2A, the first fanout circuitry 126 disposed on the substrate 104 is fanned by a conductive layer 126e1, a conductive layer 126e2, a dielectric layer 126f1 and a dielectric layer 126f2. The conductive layer 126e1 and the conductive layer 126e2 are isolated by the dielectric layer 126f1 and the dielectric layer 126f2 such that a multi-layered routing structure is formed. It can be seen from FIG. 2A that the first fanout circuitry 126 is formed by stacking two conductive layers 126e1 and 126e2 alternately. In this embodiment, the nearest trace to any trace in the conductive layer 126e1 is located in the conductive layer 126e2, and vice versa. Accordingly, the density of traces can be increased simultaneously when sufficient trace width and space are kept, or the trace width and spacing can become much larger than prior art while keeping the same number of traces in the same area.

FIG. 2B is a cross-sectional view of another implementation of the first fanout circuitry, which is taken along the A-A′ line in FIG. 1. With reference to FIG. 2B, the first fanout circuitry 126 is formed by a conductive circuit layer 126e1, a conductive circuit layer 126e2, a conductive circuit layer 126e3, a dielectric layer 126f1, a dielectric layer 126f2 and a dielectric layer 126f3, wherein the conductive circuit layer 126e1, the conductive circuit layer 126e2 and the conductive circuit layer 126e3 are isolated by the dielectric layer 126f1, the dielectric layer 126f2 and the dielectric layer 126f3 such that a multi-layered routing structure is formed. With the same advantage as previous embodiment, the density of trace can be increased or the trace width and spacing can be enlarged without decreasing any of them.

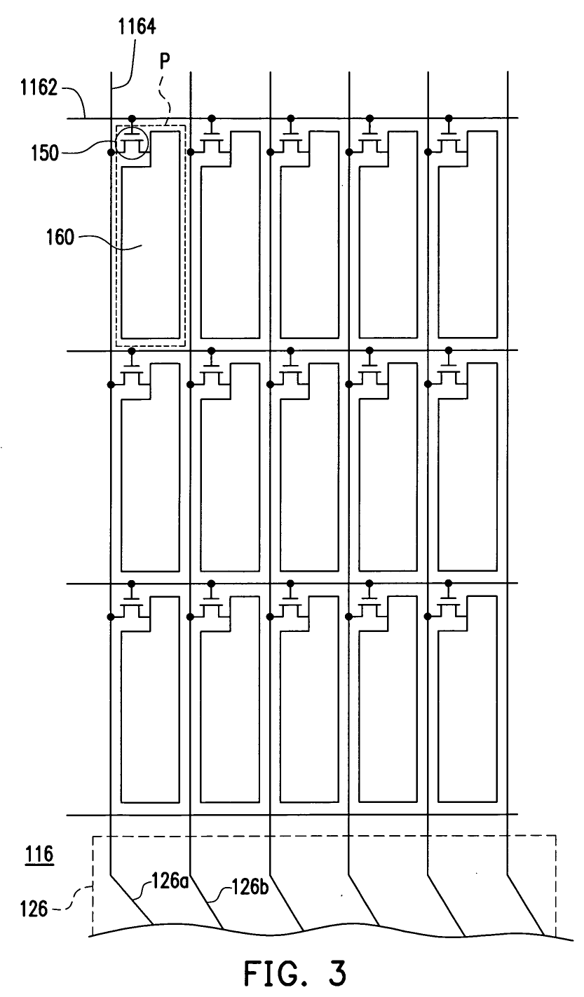

FIG. 3 is a detailed view of the Thin Film Transistor (TFT) array of the active-matrix display, which is also sowed in FIG. 1 as area A. With reference to FIG. 3. the TFT array 116 includes a plurality of scan lines 1162 and a plurality of data lines 1164 so as to define a number of pixel P. In each pixel P, a thin film transistor 150 and a pixel electrode 160 are included. The three terminals gate, source and drain of the thin film transistor 150 are coupled to the scan line 1162, the data line 1164 and the pixel electrode 160 respectively.

With reference to FIG. 1 and FIG. 3, each of the data lines 1164 is extended respectively from the display area 110 to the peripheral region 120 and connected with one of the trace in the first fanout circuitry 126. In other words, the fanout circuitry can be considered as extension of the data lines or the scan lines on the peripheral region 120.

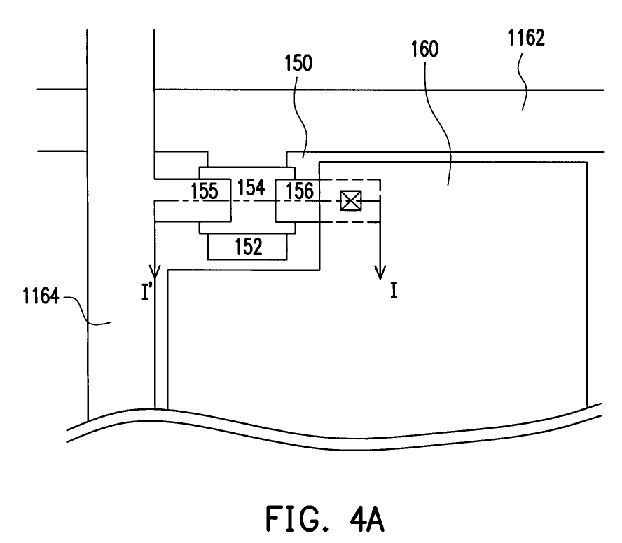

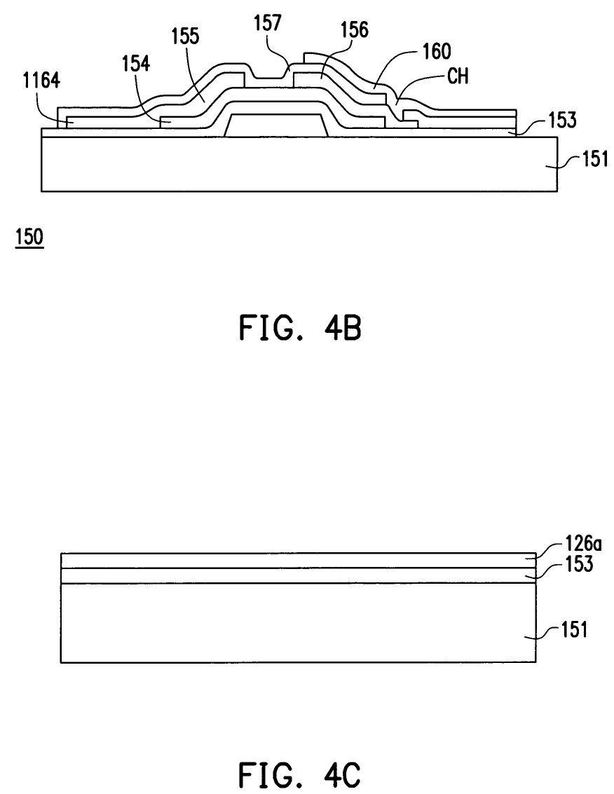

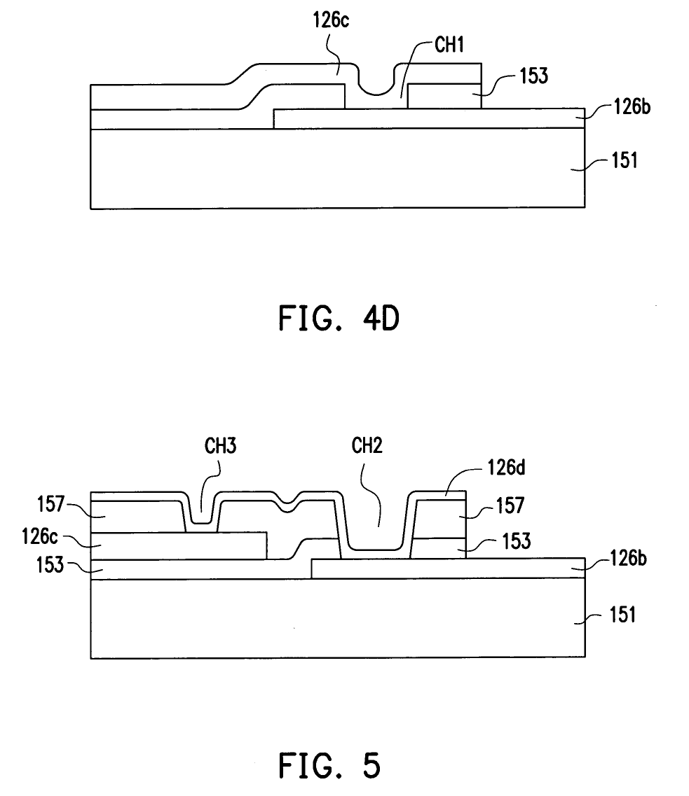

FIG. 4A and 4B are a plane view of a pixel P and a cross-sectional view of the thin film transistor taken along line I-I′ in the pixel P in FIG. 3. While FIGS. 4C and 4D are the cross-sectional views of the two adjacent traces in the first fanout circuitry along the lines II-II′ and III-III′ in FIG. 1. With reference to FIGS. 4A to 4D, the adjacent traces 126a and 126b are traces formed by two different layers of the multi-layered routing structure.

In the present embodiment, the thin film transistor 150 includes a gate electrode 152, a gate insulating layer 153, a channel layer 154, a source electrode 155 and a drain electrode 156. The thin film transistor 150 can be a top gate TFT, a bottom gate TFT or other type of thin film transistor. A passivation layer 157 can be further disposed on the thin film transistor 150 to protect the thin film underneath from being damaged.

An embodiment of a fabricating process of a TFT array substrate will be used as an example to describe the fabricating method of the thin film transistor 150, the first trace 126a and the second trace 126b. However, when the fabricating process of the TFT array substrate is changed, the fabrication of the first trace 126a and the second trace 126b can be adjusted correspondingly. This embodiment is only an illustration rather than a limitation to the fabricating sequence and structural shape of the first trace 126a and the second trace 126b.

First, the gate electrode 152, the scan line 1162 and the second trace 126b are formed on the substrate 151. The fabricating method of the previously described gate electrode 152, the scan line 1162 and the second trace 126b will be described in detail as follows. A first metal layer is formed over the substrate 151 first. The first metal layer is patterned by a photolithography etching process, so that a gate electrode 152 and a scan line 1162 connected with the gate electrode 152 are respectively formed in each pixel region P; and the second trace 126b is formed on the peripheral region 120.

Next, a gate insulating layer 153 is formed on the substrate 151. In the present embodiment, the gate insulating layer 153 can be deposited on the substrate 151 by Plasma Enhance Chemical Vapor Deposition (PECVD) process. The gate insulating layer covers the gate electrode 152, the scan line 1162, the substrate 151 and a portion of the second trace 126b.

Next, as shown in FIG. 4D, a plurality of first contact holes CH1 is formed in the gate insulating layer 153. In an embodiment of the present invention, the first contact hole CH1 corresponding to the second trace 126b exposes a portion of the second trace 126b. Next, a channel layer 154 is formed at the position corresponding to the gate electrode 152 on the gate insulating layer 153.

Next, a source electrode 155 and a drain electrode 156 are formed respectively on each channel layer 154. And the data line 1164, the first trace 126a and the first connection trace 126c are formed. The fabricating method of the previously described source electrode 155, the drain electrode 156, the data line 1164, the first trace 126a and the first connection trace 126c will be described as follows.

A second metal layer is formed on the substrate 151 and is patterned by micro photo etching process to form the source electrode 155, the drain electrode 156, the data line 1164, the first trace 126a and the first connection trace 126c. The source electrode 155 and the drain electrode 156 are located on the channel layer 154; the data line 1164 is connected to the source electrode 155 of the thin film transistor 150; and the first trace 126a and the first connection trace 126c are located on the gate insulating layer 153.

The first trace 126a and the first connection trace 126c are connected to different data lines 1164, respectively. More specifically, the first trace 126a is formed on the gate insulating layer 153, and the first connection trace 126c is electrically connected with the second trace 126b on the substrate 151 through the first contact hole CH1 on the gate insulating layer 153. As a result, the first trace 126a and the second trace 126b can be located in the circuit patterns of different layers. In the present invention, the dielectric material is used for insulation among the circuit patterns of different layers.

Next, a passivation layer 157 is formed over the substrate 151 to cover the gate insulating layer 153, the channel layer 154, the source electrode 155 and the drain electrode 156, so as to avoid the above films from being damaged.

Next, the location of the contact hole CH is defined. In the present embodiment, a photolithographic etching process is performed to pattern the passivation layer 157, so that a contact hole CH is formed at the location corresponding to the drain electrode 156 in the passivation layer 157.

Next, the pixel electrode 160 is formed. The method of forming the pixel electrode 160 will be described in the followings. A third conductive layer is formed over the passivation layer 157 and is patterned to form the pixel electrode 160. In the present embodiment, the pixel electrode 160 is electrically connected to the thin film transistor 150 through the contact hole CH, thus the fabrication of the thin film transistor 150 and the pixel electrode 160 is completed. In general, the pixel electrode 160 usually comprises indium tin oxide (ITO) or other transparent materials.

FIG. 5 is a cross-sectional view of the structure of the second trace formed on the substrate in another embodiment of the present invention. With reference to FIG. 5, in the present embodiment, the second trace 126b on the substrate 151 and the first connection trace 126c on the gate insulating layer 153 are electrically connected through the second connection hole CH2, the third contact hole CH3 and the second connection trace 126d. As shown in FIG. 5, the second connection hole CH2 is formed above the substrate 151, the third contact hole CR3 is formed above the first connection trace 126c and the second connection trace 126d is formed over the passivation layer 157, the second contact hole CH2 and the third contact hole CH3. The method of forming the second trace 126b will be described as follows through an embodiment.

First, a second trace 126b is formed on the substrate 151. In an embodiment of the present invention, a first metal layer is formed on the substrate 151 first, and is patterned to form the second trace 126b.

Next, a gate insulating layer 153 is formed over the substrate 151. Specifically, the gate insulating layer 153 covers a portion of the second trace 126b.

Next, the first connection trace 126c is formed. The forming method will be described through an embodiment as follows. A second metal layer is formed over the gate insulating layer 153 first, and is patterned to form the first connection trace 126c. And there is no direct electrical connection between the first connection trace 126c and the second trace 126b.

Next, a passivation layer 157 is formed over the second metal layer, and a second contact hole CH2 and a third contact hole CH3 are formed in the passivation layer 157. In an embodiment of the present invention, a passivation layer 157 is formed over the second metal layer and is patterned, so that a second contact hole CH2 and a third contact hole CH3 are formed respectively at the location corresponding to the second trace 126b and the first connection trace 126c in the passivation layer 157.

Ultimately, a second connection trace 126d is formed. The method thereof will be described in the followings. A third conductive layer is formed over the passivation layer 157, and is patterned to form the second connection trace 126d. The first connection trace 126c is electrically connected with the second trace 126b through the second connection trace 126d.

Above description merely exemplifies the fabricating method of the trace 126b in two different structures. Either ways can provide appropriate connections from one conductive layer to another. Circuit in single-layer structure, such as scan lines or data lines, can be extended and coupled to multi-layered fanout circuitry through abovementioned methods, However, different methods other than abovementioned can be used to achieve the extension between different layers. The above embodiment is only an illustration rather than a limitation to the present invention. Various modifications and similar arrangements included within the spirit and scope of the claim is intended to be covered within the scope of the present invention.

In addition, in the present embodiment, the first fanout circuitry 126 (with reference to FIG. 1) is a fanout circuitry for source drivers. A second fanout circuitry (not shown) can also be used. The second fanout circuitry is used to connect the scan line 1162 and the gate driving circuit (gate driver) 122. Moreover, a single-layered routing structure or a multi-layered routing structure can be used in the second fanout circuitry.

Similarly, a user can apply the multi-layered routing structure of the present invention to the fanout circuitry for gate drivers of the active-matrix display panel according to different design requirements, and in this case, the fanout circuitry for source drivers can be a single-layered routing structure or a multi-layered routing Structure.

In summary, in the active-matrix display panel of the present invention, the first fanout circuitry thereof includes a multi-layered routing structure. Therefore, the number of traces required in the individual layer can be greatly reduced. Accordingly, the problem of crowding too many traces in a limited fanout area can be avoided. The line width of the traces and the spacing between the traces can thus be enlarged. The yield of the display panels can be increased, Moreover, with multi-layered structure of the first fanout circuitry, the flexibility of the trace layout is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An active-matrix display panel, including:
a display area;
a peripheral region connected with at least one side of the display area; and
a first fanout circuitry disposed on the peripheral region, wherein the first fanout circuitry is a multi-layered routing structure.

2. The active-matrix display panel of claim 1, further comprising a first driving circuit disposed on the peripheral region, and is electrically connected with the first fanout circuitry.

3. The active-matrix display panel of claim 2, wherein the driving circuit is a driver integrated circuit (driver IC) bonded on the peripheral region.

4. The active-matrix display panel of claim 2, further comprising an external circuitry electrically connected with the first driving circuit.

5. The active-matrix display panel of claim 4, further comprising a control circuit interface electrically connected with the external circuitry.

6. The active-matrix display panel of claim 1, wherein the first fanout circuitry
a plurality of conductive routing layers; and
a plurality of dielectric layers, wherein the conductive routing layers and the dielectric layers are stacked on the peripheral region alternately.

7. The active-matrix display panel of claim 6, wherein each conductive routing layer comprises a plurality of traces, while two adjacent traces of said first fanout circuitry are located on two different circuit layers.

8. The active-matrix display panel of claim 2, further comprising a second fanout circuitry disposed on the peripheral region.

9. The active-matrix display panel of claim 8, further comprising a second driving circuit disposed on the peripheral region, and is electrically connected with said second fanout circuitry.

10. The active-matrix display panel of claim 9, wherein said first driving circuit is a gate driver and said second driving circuit is a source driver.

11. The active-matrix display panel of claim 9, wherein said first driving circuit is a source driver and said second driving circuit is a gate driver.

12. The active-matrix display panel of claim 8, wherein said second fanout circuitry is a multi-layered routing structure.
